(19) United States
(12) Patent Application Publication
(10) Pub. No.: US 2005/0089725 A1
(43) Pub. Date: Apr. 28, 2005

(54) Substrate for magnetic recording medium, magnetic recording medium, and method of manufacturing the same

(75) Inventors: Mitsuru Takai, Tokyo (JP); Kazuhiro Hattori, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/932,139

(22) Filed: Sep. 2, 2004

(30) Foreign Application Priority Data
Sep. 5, 2003 (JP) 2003-314542

(51) Int. Cl. G11B 5/64; B05D 5/12; B32B 1/00

(52) U.S. Cl. 428/694 TR; 428/694 TS; 428/336; 427/126.2; 427/126.3; 427/126.4; 427/130

(57) ABSTRACT

A substrate for a magnetic recording medium with a small surface roughness at a low cost, a magnetic recording medium including the substrate for the magnetic recording medium, and a method of manufacturing the same are provided. The substrate for a magnetic recording medium includes a main substrate one face of which serves as a base surface, and a sub-substrate formed on the base surface of the main substrate by a deposition technique such as a bias sputtering method which applies a bias power thereon. In this configuration, a surface roughness of the sub-substrate is smaller than a surface roughness of the base surface of the main substrate.

### BACKGROUND OF THE INVENTION

1. Field of the Invention

The present invention relates to a substrate for a magnetic recording medium such as a hard disc, a magnetic recording medium, and a method of manufacturing the same.

2. Description of the Related Art

In the magnetic recording medium, it is important to reduce a surface roughness as much as possible to enhance recording and reading accuracies. For example, in the case of a hard disc a flying head is prevalent. In order to ensure favorable recording and reading accuracies, it is important to reduce a surface roughness as much as possible to control a gap between the flying head and the magnetic recording medium within a minute range.

Conventionally in a manufacturing process of a magnetic recording medium of a hard disc or the like, one surface or both surfaces of the substrate as a base surface is ground by a chemical mechanical polishing (referred to as CMP hereinafter) method so as to provide a flat finished surface, and a recording layer and a protective layer are formed on the base surface of the substrate by sputtering or other techniques, thereby to make the surface roughness as an entire magnetic recording medium as much small as possible (for example, refer to Japanese Patent Laid-Open Publication No. Hei 5-314471 and No. Hei 9-231562).

However, making the substrate flat in the conventional technique requires plural repeated grindings to the base surface of the substrate to obtain a desired surface roughness, causing a low productivity.

Also, in the case of using the CMP method, it is required to wash away the base surface of the substrate for removal of slurry each time for repeatedly grinding the base surface of the substrate, causing a large deterioration of productivity.

Also since the conventional substrate is low in productivity, the proportion of the substrate cost out of total costs in the magnetic recording medium is high.

### SUMMARY OF THE INVENTION

In view of the foregoing problems, various exemplary embodiments of this invention provide a substrate for a magnetic recording medium with a small surface roughness at a low cost, a magnetic recording medium including the substrate for the magnetic recording medium, and a method of manufacturing the same.

According to one exemplary embodiment of the present invention, a substrate for a magnetic recording medium includes a main substrate and a sub-substrate formed on a base surface of the main substrate wherein a surface roughness of the sub-substrate is finished to be smaller than a surface roughness of the base surface of the main substrate to provide the substrate for a magnetic recording medium with a small surface roughness at a low cost.

A sub-substrate is formed on a base surface of a main substrate by using a deposition technique such as a bias sputtering method to deposit a nonmagnetic material thereon while applying a bias power to the main substrate. This makes it possible to efficiently manufacture the magnetic recording medium with a small surface roughness at a low cost. Namely in the deposition technique with applying the bias power a deposition function and an etching function to etch a part of a formed film by ions accelerated by the bias power are simultaneously carried out. When the deposition function exceeds the etching function, the formation of the film is developed. Since the etching function tends to selectively remove projected portions of the film earlier than the other portions of the film, the etching function restricts irregularity of a film surface to form a film on the sub-substrate with a small surface roughness. Also the sub-substrate is formed on the base surface of the main substrate where the sub-substrate is made of a material easier to be processed than a material of the main substrate. For example, the sub-substrate is made to be flat by dry etching such as ion beam etching or the like, and as a result a substrate of a magnetic recording medium with a small surface roughness can be manufactured efficiently and certainly at a low cost

One exemplary embodiment of the present invention provides a substrate for a magnetic recording medium with a small surface roughness at a low cost by flattening a base surface of the substrate for a magnetic recording medium by dry etching such as ion beam etching. Namely since the dry etching also has a tendency to selectively remove the projected portions of the film earlier than the other portions thereof in the same way as the etching function of the deposition technique wherein a bias power is applied, the surface of the substrate can be made flat. Since washing the surface is not needed due to using a dry process such as a dry etching instead of a wet process such as a CMP method, a substrate for a magnetic recording medium with a small surface roughness can be efficiently manufactured at a low cost.

Accordingly, various exemplary embodiments of the invention provide

A substrate for a magnetic recording medium, comprising:
a main substrate at least one face of which serves as a base surface; and
a sub-substrate formed on the base surface of the main substrate,
wherein a surface roughness of a surface of the sub-substrate is smaller than a surface roughness of the base surface of the main substrate.

Various exemplary embodiments of the invention provide

A magnetic recording medium comprising the sub-substrate of the substrate for a magnetic recording medium, wherein
a recording layer is formed directly or indirectly over the sub-substrate.

Various exemplary embodiments of the invention provide

A method of manufacturing a substrate for a magnetic recording medium, comprising the step of:
forming a sub-substrate by depositing a non-magnetic material on a base surface of a main substrate at least one face of which serves as the base surface while applying a bias power to the main substrate to obtain the substrate for a magnetic recording medium with a surface roughness of a surface of the sub-substrate being smaller than a surface roughness of the base surface of the main substrate.

Various exemplary embodiments of the invention provide

A method of manufacturing a substrate for a magnetic recording medium, comprising the steps of:
forming a sub-substrate by depositing a non-magnetic material on a base surface of a main substrate at least one face of which serves as the base surface; and
dry etching a surface of the sub-substrate to obtain the substrate for a magnetic recording medium with a surface roughness of the surface of the sub-substrate being smaller than a surface roughness of the base surface of the main substrate.

Alternatively various exemplary embodiments of the invention provide

A method of manufacturing a substrate for a magnetic recording medium, comprising the steps of:
providing a substrate at least one face of which serves as a base surface; and
flattening the base surface by dry etching.

The term “diamond-like carbon” (referred to as DLC hereinafter) used herein means a material composed mainly of carbon, and having an amorphous structure and a hardness of approximately 200 to 8,000 kgf/mm² measured as Vickers hardness.

The term “ITO (Indium Tin Oxide)” used herein collectively means a material composed mainly of In₂O₃ (indium oxide), to which a small amount (approximately 5 to 10 wt %) of SnO (tin oxide) is added.

The term “ion beam etching” used herein collectively means a process method of irradiating ionized gases such as ion milling to a work to remove a part of it, not limited to a process method of irradiation by focussing an ion beam.

Further, the term “magnetic recording medium” used herein is not limited to a hard disc, a floppy (registered trademark) disc, a magnetic tape or the like using only magnetism for recording and reading information, but includes a magnetic optical recording medium such as an MO (Magneto Optical) disc using both magnetism and light, and a heat-assisted type recording medium using both magnetism and heat.

According to various exemplary embodiments of the present invention, a substrate for a magnetic recording medium with a small surface roughness can be efficiently manufactured at a low cost. Therefore, a magnetic recording medium with a small surface roughness can be efficiently manufactured at a low cost by forming a recording layer or the like over the substrate for a magnetic recording medium.

### BRIEF DESCRIPTION OF THE DRAWINGS

Various exemplary embodiments of the present invention will be described in detail with reference to the accompanying drawings, wherein:

FIG. 1 is a cross sectional side view schematically showing the configuration of a substrate for a magnetic recording medium according to a first exemplary embodiment of the present invention;

FIG. 2 is a flow chart showing a summary of a manufacturing method of the substrate for a magnetic recording medium according to the first exemplary embodiment;

FIG. 3 is a cross sectional side view schematically showing a shape, after press molding, of a main substrate of the substrate for a magnetic recording medium according to the first exemplary embodiment;

FIG. 4 is a flow chart showing a summary of a manufacturing method of a substrate for a magnetic recording medium according to a second exemplary embodiment of the present invention;

FIG. 5 is a cross sectional side view schematically showing the configuration of the substrate for a magnetic recording medium according to the second exemplary embodiment;

FIG. 6 is a flow chart showing a summary of a manufacturing method of a substrate for a magnetic recording medium according to a third exemplary embodiment of the present invention;

FIG. 7 is a cross sectional side view schematically showing the structure of a magnetic recording medium according to a fourth exemplary embodiment of the present invention;

FIG. 8 is a flow chart showing a summary of a manufacturing method of the magnetic recording medium according to the fourth exemplary embodiment;

FIG. 9 is a cross sectional side view schematically showing the configuration of a magnetic recording medium according to a fifth exemplary embodiment of the present invention;

FIG. 10 is a cross sectional side view schematically showing the configuration of a magnetic recording medium according to a sixth exemplary embodiment of the present invention;

FIG. 11 is an AFM image showing an enlarged base surface of a main substrate after press molding in Example 1 according to the present invention;

FIG. 12 is an AFM image showing an enlarged surface of a sub-substrate in the Example 1;

FIG. 13 is an AFM image showing an enlarged surface of a sub-substrate after ion beam etching in Example 2 according to the present invention; and

FIG. 14 is an AFM image showing an enlarged surface of a substrate after ion beam etching in Example 3 according to the present invention.

### DETAILED DESCRIPTION OF THE PREFERRED EMBODIMENT

Various exemplary embodiments of the present invention will be hereinafter described in detail with reference to the drawings.

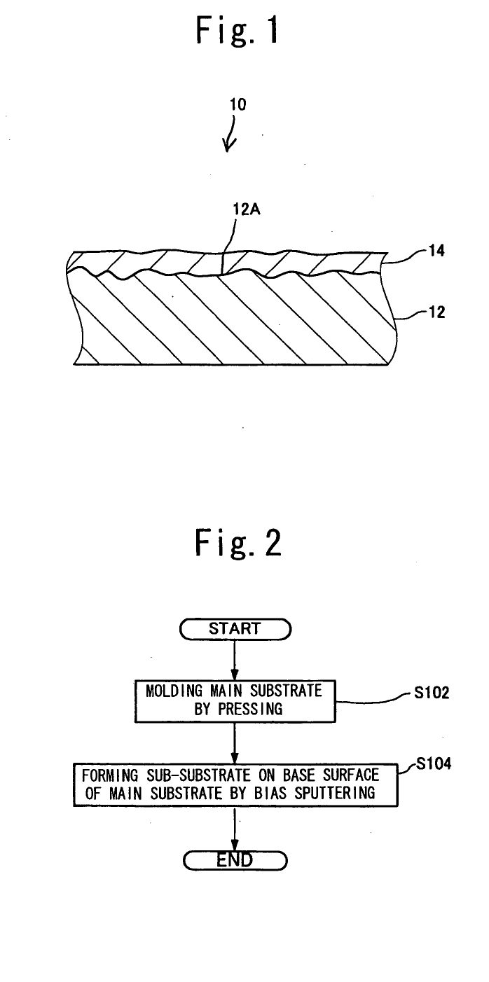

As shown in FIG. 1, a substrate 10 for a magnetic recording medium according to the present exemplary embodiment includes a main substrate 12 one surface of which serves as a base surface 12A and a sub-substrate 14 formed on the base surface 12A of the main substrate 12. The substrate 10 is characterized in that a surface roughness of the sub-substrate 14 is smaller than a surface roughness of the base surface 12A of the main substrate 12.

The main substrate 12 has a thickness of approximately 0.2 to 1 mm and is made of glass.

The sub-substrate 14 has a thickness of approximately 30 to 200 nm and is made of a non-magnetic material including any one of SiO₂ (silicon dioxide), Si (silicon), DLC, Al₂O₃ (alumina), MgO (magnesium oxide), CrO (chromium monoxide), Cr₂O₃ (dichromium trioxide), CrO₃ (chromium trioxide), carbide, nitride, and ITO. As the carbide, SiC (silicon carbide), TiC (titanium carbide), Cr₃C₂ (trichromium dicarbide), B₄C (tetraboron carbide), and Al₂O₃—TiC can be used. As the nitride, TiN (titanium nitride), Si₂N₃ (disilicon trinitride), hBN (boron nitride of hexagonal close-packed structure), and AlN (aluminum nitride) can be used.

The sub-substrate 14 has arithmetic mean deviation of the surface thereof equal to or less than 1 nm.

Next, a method of manufacturing the substrate 10 for a magnetic recording medium will be described with reference to the flow chart shown in FIG. 2.

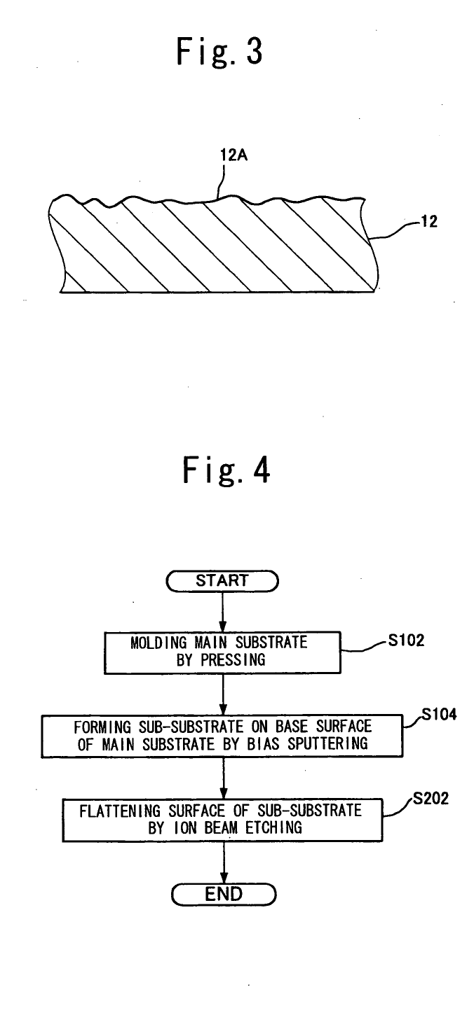

First, the main substrate 12 is molded (S102). In detail, a glass is heated to be in a molten state and then, is molded into a sheet shape by a press molding. Thereby the main substrate 12 is, as shown in FIG. 3, produced, having arithmetic mean deviation of the base surface 12A of approximately 10 to 20 nm.

Next, a bias power is applied to the main substrate 12 by a bias sputtering method to form the sub-substrate 14 on the substrate 12 depositing a non-magnetic material containing any of SiO₂, Si, DLC, Al₂O₃, MgO, Cr₃O₂, Cr₃O₂, carbide, nitride, and ITO (S104).

On this occasion, both the deposition function of the non-magnetic material by sputtering, and the etching function to etch a part of the deposited non-magnetic material by the ions accelerated by the bias power are simultaneously carried out. When the deposition function exceeds the etching function, the formation of the film is developed. The deposition function by the sputtering has a tendency to deposit the non-magnetic material while copying a surface shape of the base surface 12A of the main substrate 12. On the other hand since the etching function has a tendency to selectively remove the projected portions of the film earlier than the other portions thereof, concavo-convex shape of the surface of the sub-substrate 14 is restricted by this etching function. As a result, the arithmetic mean deviation of the surface of the sub-substrate 14 is smaller than that of the base surface 12A of the main substrate 12, to be approximately 0.5 to 2 nm and then the substrate 10 for the magnetic recording medium as shown in FIG. 1 is completed.

In the substrate 10 for the magnetic recording medium according to the present exemplary embodiment, the sub-substrate 14 is deposited on the main substrate 12 by the sputtering method instead of by the conventional grinding method to the substrate. This makes it possible to restrain the surface roughness of the substrate to be small and to efficiently manufacture the substrate at a low cost.

For example, a material such as glass having an excellent stability in shape is used as a material for the main substrate 12. On the other hand, a material such as SiO₂ easier to be deposited by the bias sputtering than the glass is used as a material of the sub-substrate 14. Thereby the substrate for a magnetic recording medium which is small in surface roughness and excellent in shape stability and manufactured at a low cost is provided.

By forming a recording layer or the like over such a substrate 10 for a magnetic recording medium which is small in surface roughness and manufactured at a low cost, a magnetic record medium which is small in surface roughness can be efficiently manufactured at a low cost.

Further, in the first exemplary embodiment, the sub-substrate 14 is formed on the main substrate 12 by the bias sputtering method. However, the deposition technique is not limited as long as the sub-substrate 14 can be formed on the surface of the main substrate 12 by applying a bias power in the direction of the work. For example, the sub-substrate 14 may be formed by another deposition technique such as a CVD (chemical vapor deposition), or an IBD (ion beam deposition) which applies the bias power to a work.

Next, a second exemplary embodiment of the present invention will be explained.

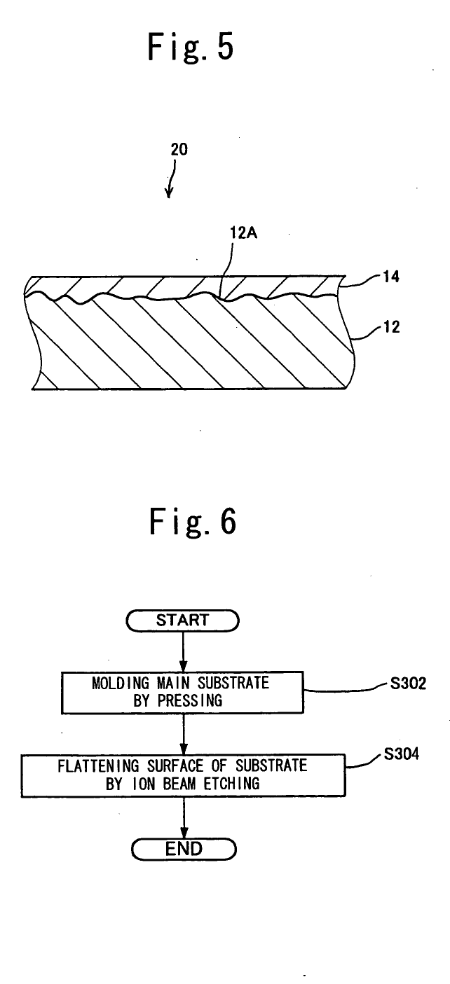

The second exemplary embodiment, as shown in a flow chart in FIG. 4, processes a surface of the sub-substrate 14 by ion beam etching after the sub-substrate-forming processing (S104) in the first exemplary embodiment, namely adds a sub-substrate-flattening processing (S202) to flatten the surface of the sub-substrate 14. The substrate 20 for a magnetic recording medium as shown in FIG. 5 is provided, having a smaller surface roughness than the substrate 10 for a magnetic recording medium according to the first exemplary embodiment. Other components in the second exemplary embodiment identical to those in the first exemplary embodiment are omitted.

In detail, the surface of the sub-substrate 14, which has been formed by the bias sputtering, is irradiated with an ion beam such as Ar (Argon) in the oblique direction thereto, thereby removing and flattening the surface of the sub-substrate 14. In this case an incident angle of the ion beam is preferably in the range of −10 to 15°. However, if a favorable flattening is produced in the sub-substrate-forming processing (S104), the incident angle of Ar ion may be in the range of 30 to 90°. With such a way, a processing speed for the surface becomes high to improve productivity of the substrate. Herein, the term “incident angle” means an incident angle to the surface of the sub-substrate 14 and is used as an angle formed between a surface of the work and a central axis of the ion beam. For example, in case where the central axis of the ion beam is in parallel with the surface of the sub-substrate 14, the incident angle is 0° and in case where the ion beam is incident perpendicular to the surface of the sub-substrate 14, the incident angle is +90°.

The ion beam etching has a tendency to selectively remove portions projected from a surface earlier than other portions thereof, the surface of the sub-substrate 14 is further flattened and arithmetic mean deviation of the surface becomes approximately 0.1 to 1 nm, and the substrate 10 for a magnetic record medium is completed as shown in FIG. 5.

Thus flattening the surface of the sub-substrate 14 by the ion beam etching method can restrict the surface roughness of the sub-substrate much smaller.

In the second exemplary embodiment, it is preferable that SiO₂ which is easier to be deposited by the bias sputtering, and to be flattened by the ion beam etching than a glass material be used as a material of the sub-substrate 14.

In the second exemplary embodiment the surface of the sub-substrate 14 is flattened by the ion beam etching, and it may be flattened by another dry etching technique such as reactive ion etching or reactive ion beam etching.

Also in the first and second exemplary embodiments, the substrate 10 for a magnetic recording medium has a two-layer structure where the sub-substrate 14 is formed on the base surface 12A of the main substrate 12. However, it may be a substrate for a magnetic recording medium having a three-layer structure or more. For example, a first sub-substrate, made of a material suitable for a deposition technique which applies a bias power such as a bias sputtering, is formed on a main substrate first, and further, on the first sub-substrate, a second sub-substrate made of a material suitable for a dry etching method such as an ion beam etching may be formed.

A third exemplary embodiment of the present invention will be described next.

In the first exemplary embodiments the substrate 10 for a magnetic recording medium has the two-layer structure where the sub-substrate 14 is formed on the base surface 12A of the main substrate 12. On the contrary, the third exemplary embodiment manufactures a single layer-substrate for a magnetic recording medium with a small surface roughness in a way that, as shown in a flow chart in FIG. 6, a substrate is molded by pressing (S302), and a base surface of the substrate (refer to FIG. 3) is flattened directly by the ion beam etching (S304). Since in the third exemplary embodiment the substrate for a magnetic recording medium is flattened by a dry process (ion beam etching), the substrate for a magnetic recording medium can be efficiently manufactured at a low cost as compared to the manufacturing method using a wet process like the conventional CMP method. Also since deposition of the sub-substrate is not needed, the third exemplary embodiment can improve productivity in this respect.

In the third exemplary embodiment, the base surface 12A of the main substrate 12 is flattened by the ion beam etching, but the base surface 12A of the main substrate 12 may be flattened by using another dry etching technique such as a reactive ion etching or a reactive ion beam etching.

Selection of any of the manufacturing methods in the first to third exemplary embodiments as explained above may be made depending on materials of the main substrate and the sub-substrate, and a required surface roughness of a substrate for a magnetic recording medium.

Next, a fourth exemplary embodiment will be described.

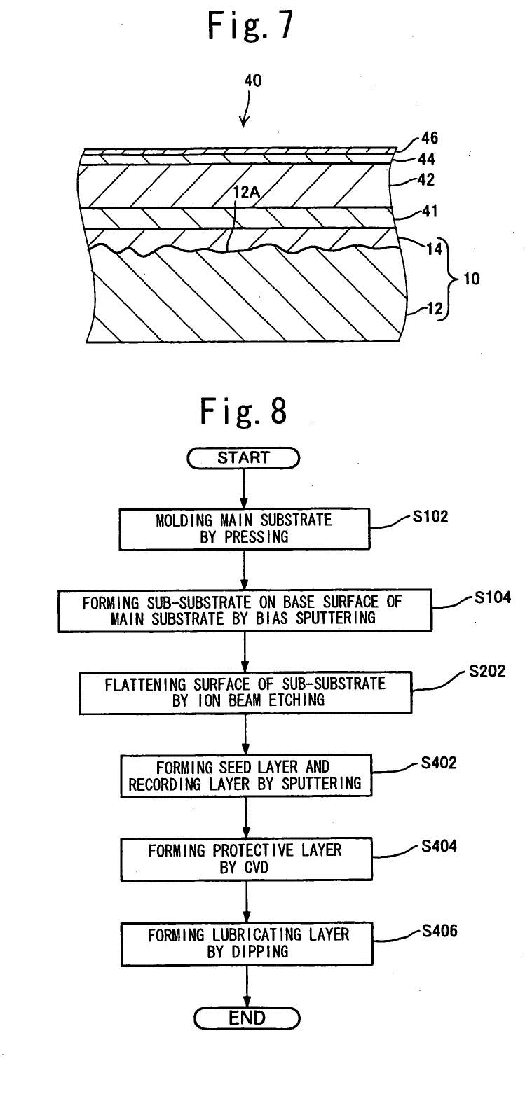

The fourth exemplary embodiment relates to a magnetic recording medium 40 as shown in FIG. 7. The magnetic recording medium 40 includes a recording layer 42 or the like which is formed over the sub-substrate 14 of the substrate 20 for a magnetic recording medium according to the second exemplary embodiment. Explanations of other components in the fourth exemplary embodiment identical to those in the conventional magnetic recording medium are omitted.

The magnetic recording medium 40 includes a seed layer 41, a recording layer 42, a protective layer 44, and a lubricating layer 46 in this order over the sub-substrate 14 of the substrate 20 for a magnetic recording medium.

The seed layer 41 is made of a material such as Cr (chromium), a non-magnetic CoCr (cobalt-chromium) alloy, MgO (magnesium oxide), Ti (titanium) and have a thickness of 5 to 30 nm.

The recording layer 42 is made of a material such as a CoCr alloy, having a thickness of 5 to 30 nm.

The protective layer 44 is made of a material such as a hard carbon film called as the above-mentioned DLC, having a thickness of 1 to 5 nm.

The lubricating layer 46 is made of a material such as PFPE (perfluoropolyether), having a thickness of 1 to 2 nm.

In the magnetic recording medium 40, as shown in a flow chart in FIG. 8, the seed layer 41 and the recording layer 42 are formed over the sub-substrate 14 of the substrate 10 for a magnetic recording medium by sputtering (S402). Then, the protective layer 44 is formed by the CVD method (S404), and further, the lubricating layer 46 is formed by a dipping method (S406). Thereby, the magnetic recording medium 40 is completed.

Since the surface roughness of the sub-substrate 14 of the substrate 20 for a magnetic recording medium is small, the surface roughness of each of the seed layer 41, the recording layer 42, the protective layer 44, and the lubricating layer 46 is restricted to be small.

Thus, by using the substrate 20 for a magnetic recording medium with a good productivity at a low cost in the manufacturing, the magnetic recording medium with a small surface roughness can be efficiently manufactured at a low cost.

Next, a fifth exemplary embodiment of the present invention will be described.

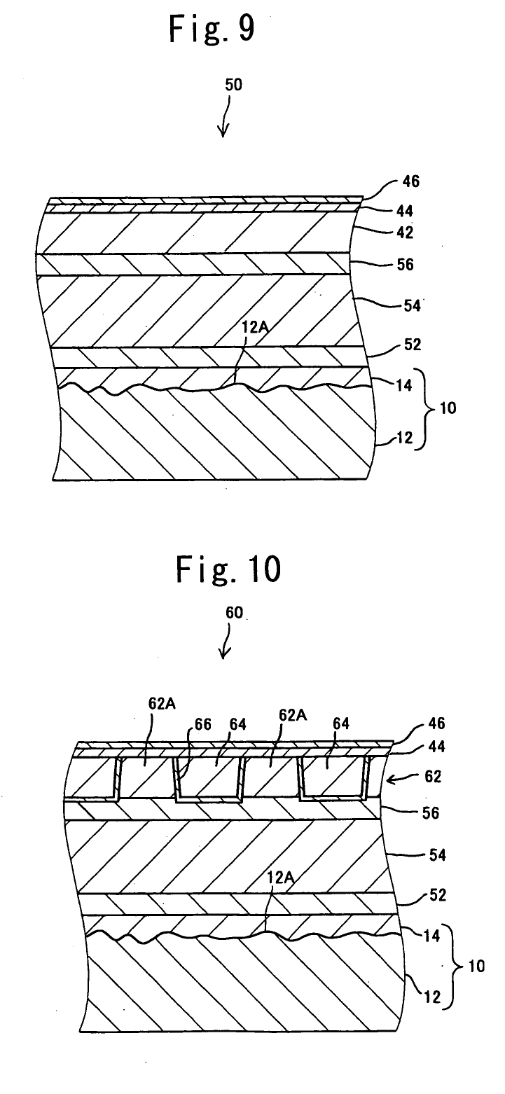

The fifth exemplary embodiment relates to a magnetic recording medium 50 as shown in FIG. 9. The magnetic recording medium 50 is a vertical recording type where an underlayer 52, a soft magnetic layer 54, and an seed layer 56 are formed over the sub-substrate 14 of the substrate 20 for the magnetic recording medium in contrast to the magnetic recording medium 40 of the fourth embodiment. In this configuration, a recording layer 22 is indirectly formed over these layers. Other components in the fifth exemplary embodiment identical to those in the fourth exemplary embodiment are referred to as identical numerals in FIGS. 7 and 8, and an explanation thereof is omitted.

The underlayer 52 is formed of a material such as Ta (tantalum), Cr, or Cr alloy, having a thickness of 30 to 200 nm.

The soft magnetic layer 54 is formed of a material such as Fe (iron) alloy, or Co (cobalt) alloy, having a thickness of 50 to 300 nm.

The seed layer 56 is made of a material such as Cr, non-magnetic CoCr alloy, MgO, and Ti, having a thickness of 3 to 30 nm.

In the magnetic recording medium 50, the underlayer 52, the soft magnetic layer 54, and the seed layer 56 are formed over the sub-substrate 14 of the substrate 20 for a magnetic recording medium by sputtering. Furthermore, the recording layer 42, the protective layer 44, and the lubricating layer 46 are formed in the same manner as in the fourth embodiment.

Thus, by using the substrate 20 for a magnetic recording medium with a good productivity and at a low cost in the manufacturing, the magnetic recording medium 50 with a small surface roughness can be efficiently manufactured at a low cost in the same manner as in the magnetic recording medium 40 of the fourth embodiment.

Next, a sixth exemplary embodiment of the present invention will be described.

The sixth exemplary embodiment relates to a magnetic recording medium 60 as shown in FIG. 10. The magnetic recording medium 60 is a discrete track type one wherein, in contrast to the magnetic recording medium 50, the recording layer 62 is divided into many recording elements 62A, and a concave portion between the recording elements 62A is filled with a non-magnetic material 64. Further, barrier layers 66 are formed on a side face and a bottom face in the concave portion between the recording elements 62A. Other components in the sixth exemplary embodiment identical to those in the fifth embodiment are referred to as identical numerals in FIG. 9 and an explanation thereof is omitted.

The non-magnetic material 64 is made of a material such as SiO₂ (silicon dioxide) . Also, the barrier layer 66 is made of a material such as a hard carbon film called as DLC described above.

In the magnetic recording medium 60, the underlayer 52, the soft magnetic layer 54, the seed layer 56, a continuous recording layer (not shown), a plurality of mask layers (not shown), and a resist layer (not shown) are formed over the sub-substrate 14 of the substrate 20 for a magnetic recording medium by sputtering or the like, and the recording layer 62 is formed by dividing the continuous recording layer into many recording elements 62A by using a lithography, or a dry etching method. Then, the barrier layers 66 are formed by the CVD method or the like. The concave portion between the recording elements 62A is filled with the non-magnetic material 64, and then, it is flattened by the ion beam etching or the like. Thereafter, the protective layer 44 and the lubricating layer 46 are formed thereon to complete the magnetic recording medium 60.

Herein an explanation of the mask layer, a material of the resist layer, a method such as the lithography and the dry etching for dividing/processing the continuous recording layer is omitted since it does not seem necessary for understanding the present invention.

The magnetic recording medium 60 with a small surface roughness can be also efficiently manufactured at a low cost by using the substrate 20 for a magnetic recording medium with a good productivity and at a low cost in the manufacturing.

Although in the fourth to sixth exemplary embodiments, the recording layer and the like are formed over the substrate 20 for a magnetic recording medium according to the second exemplary embodiment, in case where the recording layer is formed over the substrate for the magnetic recording medium provided by the first or third exemplary embodiment, the magnetic recording medium with a small surface roughness can be efficiently manufactured at a low cost in the same way as in the fourth to sixth exemplary embodiments.

In the first to third exemplary embodiments, one side of the main substrate 12 serves as the base surface 12A, and in the fourth to sixth embodiments, the recording layer is formed over one side of the substrate 20 for the magnetic recording medium. However, if the sub-substrates are formed on both surfaces of the main substrate as base surfaces by the deposition technique which applies a bias power such as a bias sputtering method to both the base surfaces of the main substrate, and the recording layers are formed over the base surfaces of both sides, the magnetic recording medium with a small surface roughness of both sides can be efficiently manufactured at a low cost. In addition the surface of the sub-substrates may be flattened by a dry etching such as the ion beam etching or the like.

The base surfaces, or both the surfaces of the main substrate may be flattened directly by the dry etching such as the ion beam etching, and the recording layers may be formed on both sides of the substrate for a magnetic recording medium. The one sub-substrate may be formed on one base surface of the main substrate by deposition technique which applies a bias power such as a bias sputtering method or the like, and the other base surface may be flattened by a dry etching such as the ion beam etching.

The fourth to sixth exemplary embodiments show some examples of the magnetic recording medium using one of the substrates for the magnetic storage media according to the first to third exemplary embodiments. When the substrate for a magnetic recording medium according to the first to third exemplary embodiments are used, the magnetic recording media each having various structures can be efficiently manufactured at a low cost with the surface roughness restricted.

For example, in the first to sixth exemplary embodiments, a material of the main substrate 12 is glass. However, as a material of the main substrate, a non-magnetic material including Al₂O₃ (alumina), Si (silicon), glassy carbon, and a resin may be used. As a material of the sub-substrate 14, SiO₂ (silicon dioxide), Si, DLC, Al₂O₃, MgO, Cr₃C₃, Cr₃O₂, carbide, nitride, and ITO are exemplified. However, other non-magnetic materials may be used. Further, as a material of the sub-substrate 14, a material suitable for a deposition technique which applies a bias power or for processing by a dry etching is preferable.

In the fourth to sixth exemplary embodiments, a material of the recording layer 42 (62) is a CoCr alloy. However, the exemplary embodiments of the present invention can be applied for manufacturing a magnetic recording medium having a recording layer made of other alloys, for example, including iron group elements (Co, Fe (iron), and Ni), or other materials such as a laminated body of these alloys.

In the fifth and sixth exemplary embodiments, the underlayer 52, the soft magnetic layer 54, and the seed layer 56 are formed below the recording layer 42 (62). The configuration of layers below the recording layer 42 (62) may be changed depending on the kind of the magnetic recording medium. For example, one or two of the underlayer 14, the soft magnetic layer 16, and the seed layer 18 may be omitted or each layer may be formed of a plurality of layers.

In the sixth exemplary embodiment, the magnetic recording medium 60 is of a discrete track type on a vertical recording system in which the recording elements 62A are spaced by a minute distance in parallel in the radial direction of a track. The exemplary embodiment of this invention can be applied to a magnetic disc in which recording elements are spaced by a minute distance in parallel in the peripheral direction (sector direction) of the track, to a magnetic disc in which recording elements are spaced by a minute distance in parallel in both radial and peripheral directions or to a magnetic disc in which the recording element is formed with a spiral pattern. The exemplary embodiments of the present invention can also be applied to a magneto optical disc of MO disc or the like or a heat-assisted recording disc using both magnetism and heat.

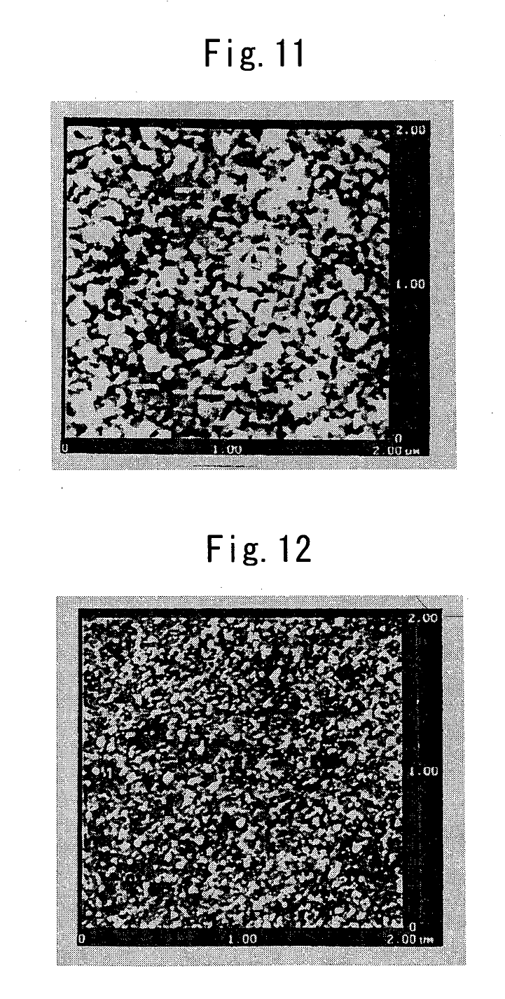

A substrate 10 for a magnetic recording medium was manufactured in the same manner as described in the first exemplary embodiment. In detail, a main substrate 12 made of glass was press-molded first. The substrate 12 had a diameter of approximately 21.6 mm, a thickness of approximately 0.38 mm, and a central hole with an inner diameter being approximately 6.0 mm. When the base surface 12A of the main substrate 12 was shot by AFM (atomic force microscope), an image as shown in FIG. 11 was obtained. When arithmetic mean deviation Ra of the base surface 12A of the main substrate 12 was measured, it was approximately 12.37 nm.

Next, the sub-substrate 14 having a thickness of approximately 500 nm was deposited on the base surface 12A of the main substrate 12 by the bias sputtering method.

Ar gas was used for the bias sputtering and the bias sputtering conditions were set as follows:

| | | |
|---|---|---|
| Ar gas flow | 100 | sccm |
| Gas pressure | 1.0 | Pa |
| Input Power | 500 | W |
| Substrate Bias Power | 250 | W. |

An image as shown in FIG. 12 was obtained by shooting the surface of the sub-substrate 14 with the AFM (atomic force microscope). When arithmetic mean deviation Ra of the surface of the sub-substrate 14 was measured, it was approximately 0.83 nm. Namely it was confirmed that the surface roughness of the sub-substrate 14 was significantly reduced as compared to the surface roughness of the base surface 12A of the main substrate 12.

### EXAMPLE 2

A substrate 20 for a magnetic recording medium was manufactured in the same manner as described in the second exemplary embodiment. In detail, the surface of the sub-substrate 14 of the substrate 10 for a magnetic recording medium obtained in Example 1 was flattened by ion beam etching. Ar gas was used for the ion beam etching and the ion beam etching condition was set as follows:

| | | |
|---|---|---|
| Ar Gas flow | 11 | sccm |
| Gas Pressure | 0.05 | Pa |
| Beam Voltage | 500 | V |
| Beam Current | 500 | mA |
| Suppressor Voltage | 400 | V |

| | |
|---|---|
| Ion Beam Incident Angle | 3°. |

The substrate 10 for a magnetic recording medium was processed under rotation.

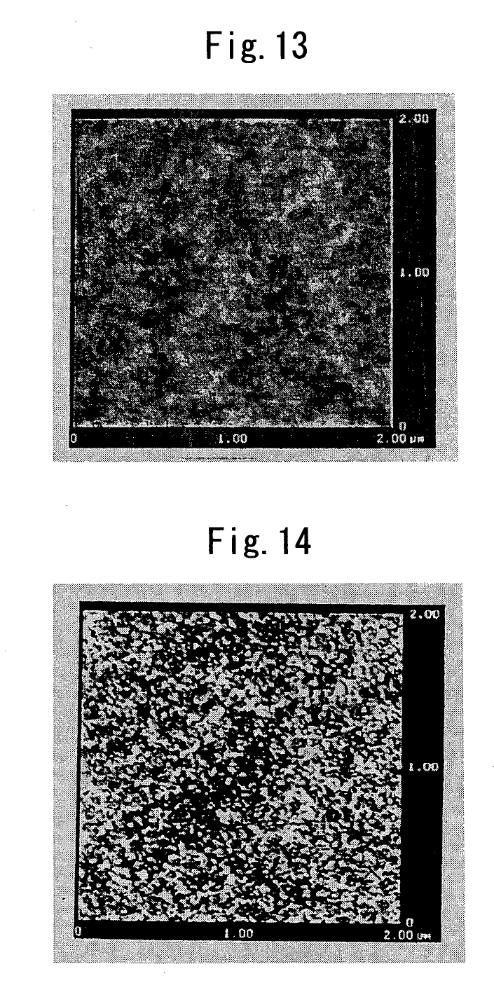

An image as shown in FIG. 13 was obtained by shooting the surface of the sub-substrate 14 of the substrate 20 for a magnetic recording medium with the AFM (atomic force microscope). When arithmetic mean deviation Ra of the surface of the sub-substrate 14 was measured based upon FIG. 13, it was approximately 0.59 nm. Namely it was confirmed that the surface roughness of the sub-substrate 14 was further reduced than in Example 1.

### EXAMPLE 3

The substrate for a magnetic recording medium was manufactured in the same manner as described in the third exemplary embodiment. In detail, the base surface 12A of the main substrate 12 obtained in Example 1 described above was flattened by ion beam etching. Ar gas was used for the ion beam etching similarly to Example 2 and the ion beam etching condition also was set as in the Example 2.

An image as shown in FIG. 14 was obtained by shooting the surface of the substrate for a magnetic recording medium with the AFM (atomic force microscope). When arithmetic mean deviation Ra of the surface was measured based upon FIG. 14, it was approximately 0.71 nm. Namely it was confirmed that the surface roughness of the base surface 12A of the main substrate 12 was significantly reduced by the ion beam etching.

The exemplary embodiments of present invention can be utilized for efficiently manufacturing a magnetic recording medium with a small surface roughness at a low cost.

1. A substrate for a magnetic recording medium, comprising:
a main substrate at least one face of which serves as a base surface; and
a sub-substrate formed on the base surface of the main substrate,
wherein a surface roughness of a surface of the sub-substrate is smaller than a surface roughness of the base surface of the main substrate.

2. The substrate for a magnetic recording medium according to claim 1, wherein
arithmetic mean deviation of the surface of the sub-substrate is equal to or less than 1 nm.

3. The substrate for a magnetic recording medium according to claim 1, wherein
a material of the sub-substrate includes at least one selected from the group consisting of silicon dioxide, silicon, diamond-like carbon, alumina, magnesium oxide, chromium oxide, carbide, nitride, and ITO.

4. The substrate for a magnetic recording medium according to claim 1, wherein
a material of the main substrate includes at least one selected from the group consisting of glass, alumina, silicon, glassy carbon, and a resin.

5. A magnetic recording medium comprising the sub-substrate of the substrate for a magnetic recording medium according to claim 1, wherein
a recording layer is formed directly or indirectly over the sub-substrate.

6. A method of manufacturing a substrate for a magnetic recording medium, comprising the step of:
forming a sub-substrate by depositing a non-magnetic material on a base surface of a main substrate at least one face of which serves as the base surface while applying a bias power to the main substrate to obtain the substrate for a magnetic recording medium with a surface roughness of a surface of the sub-substrate being smaller than a surface roughness of the base surface of the main substrate.

7. A method of manufacturing a substrate for a magnetic recording medium, comprising the steps of:
forming a sub-substrate by depositing a non-magnetic material on a base surface of a main substrate at least one face of which serves as the base surface; and
dry etching a surface of the sub-substrate to obtain the substrate for a magnetic recording medium with a surface roughness of the surface of the sub-substrate being smaller than a surface roughness of the base surface of the main substrate.

8. The method of manufacturing a substrate for a magnetic recording medium according to claim 6, wherein
a material of the sub-substrate includes at least one selected from the group consisting of silicon dioxide, silicon, diamond-like carbon, alumina, magnesium oxide, chromium oxide, carbide, nitride, and ITO.

9. The method of manufacturing a substrate for a magnetic recording medium according to claim 7, wherein
a material of the sub-substrate includes at least one selected from the group consisting of silicon dioxide, silicon, diamond-like carbon, alumina, magnesium oxide, chromium oxide, carbide, nitride, and ITO.

10. The method of manufacturing a substrate for a magnetic recording medium according to claim 6, wherein
a material of the main substrate includes at least one selected from the group consisting of glass, alumina, silicon, glassy carbon, and a resin.

11. The method of manufacturing a substrate for a magnetic recording medium according to claim 7, wherein
a material of the main substrate includes at least one selected from the group consisting of glass, alumina, silicon, glassy carbon, and a resin.

12. A method of manufacturing a substrate for a magnetic recording medium, comprising the steps of:
providing a substrate at least one face of which serves as a base surface; and
flattening the base surface by dry etching.

13. The method of manufacturing a substrate for a magnetic recording medium according to claim 6, wherein
a surface of the substrate is finished so that arithmetic mean deviation of the surface of the substrate is equal to or less than 1 nm.

14. The method of manufacturing a substrate for a magnetic recording medium according to claim 7, wherein
a surface of the substrate is finished so that arithmetic mean deviation of the surface of the substrate is equal to or less than 1 nm.

15. The method of manufacturing a substrate for a magnetic recording medium according to claim 12, wherein
a surface of the substrate is finished so that arithmetic mean deviation of the surface of the substrate is equal to or less than 1 nm.

16. A method of manufacturing a magnetic recording medium comprising the steps of:
manufacturing a substrate for a magnetic recording medium by the method of manufacturing the substrate for a magnetic recording medium according to claim 6; and
forming a recording layer directly or indirectly over the substrate.

17. A method of manufacturing a magnetic recording medium comprising the steps of:
manufacturing a substrate for a magnetic recording medium by the method of manufacturing the substrate for a magnetic recording medium according to claim 7; and
forming a recording layer directly or indirectly over the substrate.

18. A method of manufacturing a magnetic recording medium comprising the steps of:
manufacturing a substrate for a magnetic recording medium by the method of manufacturing the substrate for a magnetic recording medium according to claim 12; and
forming a recording layer directly or indirectly over the substrate.
